(19) United States
(12) Patent Application Publication
(10) Pub. No.: US 2013/0076802 A1
(43) Pub. Date: Mar. 28, 2013

(54) DISPLAY DEVICE, DRIVE CIRCUIT, DRIVING METHOD, AND ELECTRONIC SYSTEM

(71) Applicant: Tomoro Yoshinaga, Kanagawa (JP)

(72) Inventor: Tomoro Yoshinaga, Kanagawa (JP)

(73) Assignee: SONY CORPORATION, Tokyo (JP)

(21) Appl. No.: 13/612,060

(22) Filed: Sep. 12, 2012

(30) Foreign Application Priority Data
Sep. 22, 2011 (JP) 2011-207141

(51) Int. Cl. G09G 5/10

(52) U.S. Cl. 345/690

(57) ABSTRACT

A drive circuit includes: a control section generating address information by which a horizontal line to be driven in a display section is designated, the display section including a plurality of display pixels; and a driving section driving, at a drive interval that conforms to a weight of each bit in a gray-scale code that includes the bits, the display pixels based on a value of each of the bits, within a unit driving period that is set to drive the horizontal line designated by the address information. The control section sets a start timing of the unit driving period on an optional basis.

### BACKGROUND

The present disclosure relates to a display device that displays an image, a drive circuit and a driving method for the display device, and an electronic system that includes such a display device as mentioned above.

Display devices are loaded on various types of electronic system nowadays. Various types of display devices such as liquid crystal display devices, plasma display devices, organic EL (Electro Luminescence) display devices and the like are developed from the view point of image quality, power consumption and the like and are applied to various types of electronic system such as stationary television sets, cell phones, personal digital assistants and the like in accordance with their characteristics.

As a method of driving a display device, an analog drive system and a digital drive system are available. For example, the analog drive system is adapted to supply an analog pixel voltage to each pixel and is often used in the liquid crystal display devices, the organic EL display devices and the like. The digital drive system is adapted to supply a digital signal which has been subjected to, for example, pulse width modulation (PWM) to each pixel. For example, Japanese Unexamined Patent Application Publication No. 2006-343609 discloses a display device of the digital drive system that a drive voltage corresponding to each bit is supplied to each pixel at a time interval (a sub-field period) conforming to a weight of each bit of display data (a code), to control on-off operation of an electro-optical device of the pixel, thereby performing display.

### SUMMARY

Incidentally, in general, it is desirable that a display device be high in image quality. The image quality is influenced, for example, by the resolution of a display image and fineness of a gray-scale. When the display image is a moving image, for example, the refresh rate is also an important factor for the image quality. Since the characteristics of images to be displayed are different from each other depending on applications and the like such that the display device mainly displays still images, for example, in a personal computer, and it mainly displays moving images, for example, in a television set, desired properties are also different from each other accordingly. Thus, it is desirable that the display device have a high degree of freedom so as to address various applications.

It is desirable to provide a display device, a drive circuit, a driving method, and an electronic system that are allowed to increase the degree of freedom of display.

A display device according to an embodiment of the present disclosure includes: a display section including a plurality of display pixels; a control section generating address information by which a horizontal line to be driven is designated; and a driving section driving, at a drive interval that conforms to a weight of each bit in a gray-scale code that includes the bits, the display pixels based on a value of each of the bits, within a unit driving period that is set to drive the horizontal line designated by the address information. The control section sets a start timing of the unit driving period on an optional basis.

A drive circuit according to an embodiment of the present disclosure includes: a control section generating address information by which a horizontal line to be driven in a display section is designated, the display section including a plurality of display pixels; and a driving section driving, at a drive interval that conforms to a weight of each bit in a gray-scale code that includes the bits, the display pixels based on a value of each of the bits, within a unit driving period that is set to drive the horizontal line designated by the address information. The control section sets a start timing of the unit driving period on an optional basis.

A driving method according to an embodiment of the present disclosure includes: generating address information by which a horizontal line to be driven in a display section is designated, the display section including a plurality of display pixels; driving, at a drive interval that conforms to a weight of each bit in a gray-scale code that includes the bits, the display pixels based on a value of each of the bits, within a unit driving period that is set to drive the horizontal line designated by the address information; and setting a start timing of the unit driving period on an optional basis.

An electronic system according to an embodiment of the present disclosure includes: a display device; and a control section performing operation control that utilizes the display device. The display device includes: a display section including a plurality of display pixels; a control section generating address information by which a horizontal line to be driven is designated; and a driving section driving, at a drive interval that conforms to a weight of each bit in a gray-scale code that includes the bits, the display pixels based on a value of each of the bits, within a unit driving period that is set to drive the horizontal line designated by the address information. The control section sets a start timing of the unit driving period on an optional basis.

The electronic system can be, for example but not limited to, a television set, a digital camera, a personal computer, a video camera, a portable terminal such as a cell phone, and a projector.

In the display device, the drive circuit, the driving method, and the electronic system according to the embodiments of the present disclosure, the display pixels are driven based on the gray-scale code, within the unit driving period set to drive the horizontal line designated by the address information. In the above mentioned case, the start timing of the unit driving period is set on an optional basis.

According to the display device, the drive circuit, the driving method, and the electronic system of the embodiments of the present disclosure, since the start timing of the unit driving period is set on an optional basis, the degree of freedom of display is increased.

Additional features and advantages are described herein, and will be apparent from the following Detailed Description and the figures.

### BRIEF DESCRIPTION OF THE FIGURES

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating one configuration example of a display device according to an embodiment of the present disclosure.

FIG. 2 is a schematic diagram illustrating an example of a gray-scale code relating to the display device illustrated in FIG. 1.

FIG. 3 is a block diagram illustrating one configuration example of a conversion circuit illustrated in FIG. 1.

FIG. 4 is an example of a timing chart illustrating one operational example of the display device illustrated in FIG. 1.

FIG. 5 is a schematic diagram illustrating another operational example of the display device illustrated in FIG. 1.

FIG. 6 is an example of a timing chart illustrating another operational example of the display device illustrated in FIG. 1.

FIG. 7 is a schematic diagram illustrating a further operational example of the display device illustrated in FIG. 1.

FIG. 8 is an example of a timing chart illustrating a further operational example of the display device illustrated in FIG. 1.

FIG. 9 is an example of a timing chart illustrating one operational example of a peripheral circuit illustrated in FIG. 1.

FIG. 10 is a block diagram illustrating one configuration example of a display device according to another embodiment.

FIG. 11 is a block diagram illustrating one configuration example of a conversion circuit illustrated in FIG. 10.

FIG. 12 is an example of a timing chart illustrating one operational example of a peripheral circuit illustrated in FIG. 10.

FIG. 13 is a schematic diagram illustrating one operational example of a display device according to a further embodiment.

FIG. 14 is a schematic diagram illustrating one operational example of the display device illustrated in FIG. 13.

FIG. 15 is a diagram illustrating an example of an effect of the display device illustrated in FIG. 13.

FIG. 16 is an example of a timing chart illustrating one operational example of a peripheral circuit included in the display device illustrated in FIG. 13.

FIG. 17 is an example of a timing chart illustrating another operational example of the peripheral circuit included in the display device illustrated in FIG. 13.

FIG. 18 is a perspective view illustrating an example of an external configuration of a television set to which the display device according to one of the embodiments is applied.

### DETAILED DESCRIPTION

Next, preferred embodiments of the present disclosure will be described in detail with reference to the accompanying drawings. It is to be noted that description will be made in the following order.

### 1. First Embodiment

### 2. Second Embodiment

### 3. Third Embodiment

### 4. Application Examples

### 1. First Embodiment

### Configuration Example

### General Configuration Example

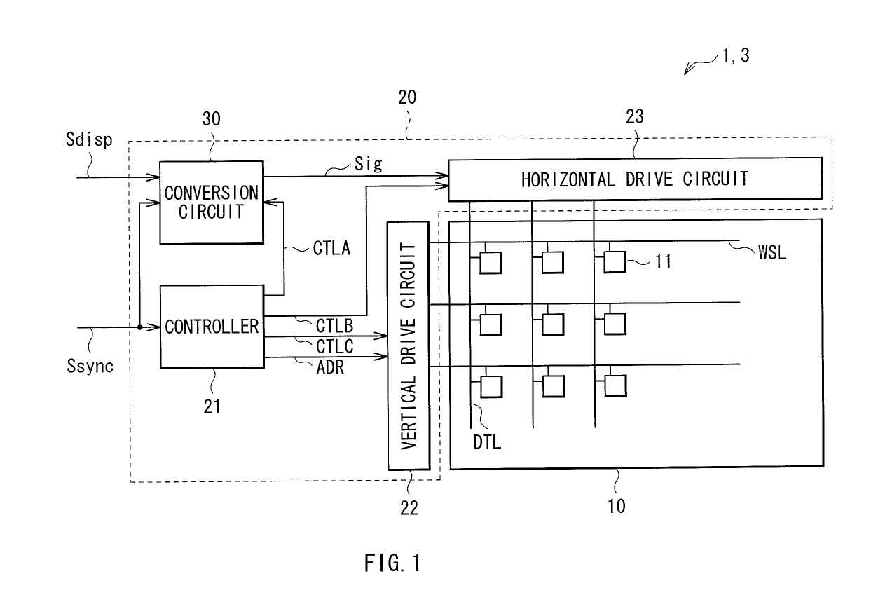

FIG. 1 illustrates a configuration example of a display device according to a first embodiment. The display device 1 is a display device of the digital drive system that performs gray-scale display with pulse width modulation. It is to be noted that since a display method according to an embodiment of the present disclosure is embodied by the present embodiment, description thereof will be made together. The display device 1 includes a display panel 10 and a peripheral circuit 20.

The display panel 10 is of the type that display of a so-called 2K1K (1920 pixels×1080 pixels) HD (high definition) image is allowed in this example. A plurality of pixels 11 are arranged in a matrix on the display panel 10 as illustrated in FIG. 1. The pixel 11 corresponds to a minimum unit point configuring a display screen on the display panel 10. When the display panel 10 is a color display panel, the pixel 11 corresponds to a sub-pixel that emits light of a single color such as, for example, red, green, yellow, or the like. When the display panel 10 is a monochromatic display panel, the pixel 11 corresponds to a pixel that emits single-colored light (for example, white light).

Although not illustrated in the drawing, the pixel 11 is a memory built-in type pixel that includes an electro-optical device, in this example. Examples of the electro-optical device include a liquid crystal cell, an organic EL (Electro Luminescence) cell, and the like. Examples of the memory include an SRAM (Static Random Access Memory), a DRAM (Dynamic Random Access Memory), and the like.

The display panel 10 includes a plurality of scan lines WSLs extending in a row direction and a plurality of data lines DTLs extending in a column direction. One ends of these scan lines WSLs and data lines DTLs are connected to the peripheral circuit 20. Each of the above mentioned pixels 11 is arranged on a place where the scan line WSL and the data line DTL mutually intersect.

Owing to the above mentioned configuration, a value of each bit is written into each pixel 11 via the data line DTL at a drive interval conforming to a weight of each bit in a gray-scale code C, within a driving period D that has the same time width as a one-frame period (1F). The value of each bit corresponds to a light-emitted state or a light-extinguished state. Then, the pixel 11 maintains the state (the light-emitted state or the light-extinguished state) for a time taken until the next writing is performed.

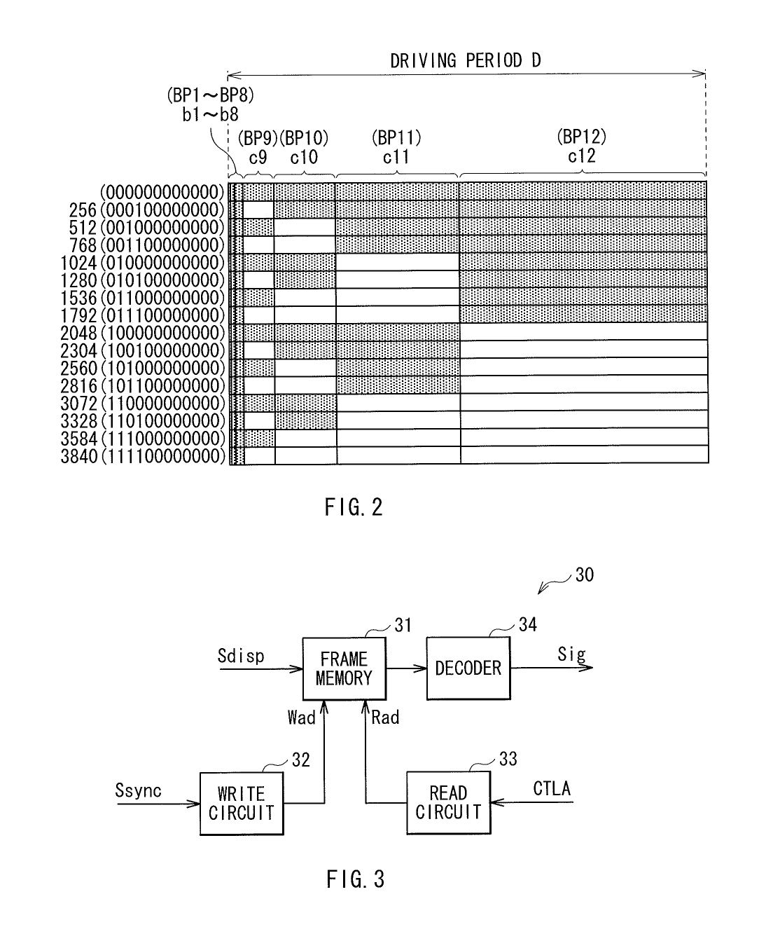

FIG. 2 schematically illustrates an example of an operation of the pixels 11. In FIG. 2, each series of numerals on the left side indicates the gray-scale code C and each drawing on the right side indicates display of each pixel 11 when the gray-scale code C has been supplied. In the drawing on the right side, a white part indicates “1” and a hutched part indicates “0”. The gray-scale code C is a 4096-step code that includes pieces of 12-bit gray-scale data b1 to b12 in this example.

The value of each bit in the gray-scale code C is written into each pixel 11 at a drive interval conforming to the weight of each bit in the gray-scale code C. The values of the respective bits are written into the pixels 11 in order starting from the low-order bit b1 in this example. Then, each pixel 11 maintains the written value of each bit for a period (a bit plane BP) conforming to the weight of the bit concerned. That is, the time widths of the bit planes BP are set at the ratio of 1 (BP1):2 (BP2):4 (BP3):8 (BP4): . . . :1024 (BP11):2048 (BP12) in accordance with the weights of the respective bits. For example, when the value of the bit concerned is “1”, the pixel 11 emits light, and when the value of the bit is “0”, it extinguishes light. Thus, the pixel 11 performs gray-scale display in accordance with a change in the ratio of a period (a light-emitted period) during which it is in a light-emitted state or a period (a light-extinguished period) during which it is in a light-extinguished state in the one-frame period. That is, the pixel 11 performs gray-scale display with pulse width modulation.

The peripheral circuit 20 is a circuit that drives the display panel 10 on the basis of an image signal S_{disp} and a synchronous signal S_{sync} supplied thereto. The image signal S_{disp} includes the gray-scale code C. Examples of the synchronous signal S_{sync} include a vertical synchronous signal V_{sync}, a horizontal synchronous signal H_{sync}, a dot clock signal, and the like.

The peripheral circuit 20 includes a controller 21, a conversion circuit 30, a vertical drive circuit 22, and a horizontal drive circuit 23.

The controller 21 is a circuit that supplies respective control signals to the conversion circuit 30, the horizontal drive circuit 23, and the vertical drive circuit 22 and controls these circuits to operate in synchronization with one another on the basis of the synchronous signal S_{sync}. Specifically, the controller 21 supplies a control signal CTLA to the conversion circuit 30, supplies a control signal CTLB to the horizontal drive circuit 23, and supplies a control signal CTLC to the vertical drive circuit 22. Examples of the control signals CTLA, CTLB, and CTLC include clock signals CLKs, latch signals, frame start signals, and the like.

In addition, the controller 21 sets a row on which a writing operation which is based on the gray-scale code C is performed on the display panel 10 per horizontal period, on the basis of which the controller 21 generates an address signal ADR and supplies the thus-generated address signal ADR to the vertical drive circuit 22. The address signal ADR includes respective pieces of 12-bit address data a0 to a11 in this example. That is, the address signal ADR is allowed to designate 2048 addresses maximum and may be used even when a 4K2K panel (the number of scan lines: 2160) is used as the display panel 10 as well as a case in which the so-called 2K1K panel (the number of scan lines: 1080) is used.

Since the controller 21 sets, on an optional basis, the row on which the writing operation is to be performed per horizontal period in the display device 1 as described above, so-called random access to the display panel 10 is allowed as described later and hence the degree of freedom of display is increased.

The conversion circuit 30 is a circuit that converts the image signal S_{disp} which is in synchronization with the synchronous signal S_{sync} into an image signal S_{ig} which is suited for driving the display panel 10. The image signal S_{ig} includes sixteen parallel signals in this example.

FIG. 3 illustrates one configuration example of the conversion circuit 30. The conversion circuit 30 includes a frame memory 31, a write circuit 32, a read circuit 33, and a decoder 34. The frame memory 31 is a memory for image display having a storage capacity preferably exceeding the resolution of the display panel 10 and stores, for example, a row address, a column address, and each piece of gray-scale data of the gray-scale code C of each pixel 11 which is made related to the row address and the column address. The write circuit 32 generates a write address W_{ad} of the gray-scale data for the frame memory 31 on the basis of the synchronous signal S_{sync} and outputs the write address W_{ad} to the frame memory 31 in synchronization with the synchronous signal S_{sync}. The write address W_{ad} includes, for example, the row address and the column address. The read circuit 33 generates a read address R_{ad} on the basis of the control signal CTLA and outputs the thus-generated read address R_{ad} to the frame memory 31. The decoder 34 outputs the gray-scale data output from the frame memory 31 as the signal data (the image signal) S_{ig}.

The vertical drive circuit 22 has a function of generating a scan line signal WS that includes a scanning pulse used for selecting the respective pixels 11 in units of rows on the basis of the control signal CTLC and the address signal ADR, and outputting the thus-generated scan line signal WS to the scan line WSL.

The horizontal drive circuit 23 generates a data line signal DT that includes the gray-scale data of each pixel 11 on the basis of the control signal CTLB and the signal data S_{ig}, and outputs the thus-generated data line signal DT to the data line DTL.

Here, the display panel 10 corresponds to one specific but not limitative example of the “display section” in one embodiment of the present disclosure. The controller 21 and the conversion circuit 30 correspond to one specific but not limitative example of the “control section” in one embodiment of the present disclosure. The vertical drive circuit 22 and the horizontal drive circuit 23 correspond to one specific but not limitative example of the “driving section” in one embodiment of the present disclosure. The driving period D corresponds to one specific but not limitative example of the “unit driving period” in one embodiment of the present disclosure. The bit plane BP corresponds to one specific but not limitative example of the “drive interval” in one embodiment of the present disclosure.

### [Operations and Effects]

Next, operations and effects of the display device 1 according to the first embodiment will be described.

### (Outline of General Operation)

First, the outline of general operation of the display device 1 will be described with reference to FIG. 1. The controller 24 generates the respective control signals CTLA, CTLB, and CTLC used for controlling the operation timings of the conversion circuit 30, the horizontal drive circuit 23, and the vertical drive circuit 22 on the basis of the synchronous signal S_{sync}, and sets the row on which the writing operation which is based on the gray-scale code C is performed on the display panel 10, on the basis of which the controller 24 generates the address signal ADR. The conversion circuit 30 converts the image signal S_{disp} which is in synchronization with the synchronous signal S_{sync} into the image signal S_{ig}. The vertical drive circuit 22 generates the scan line signal WS on the basis of the control signal CTLC and the address signal ADR. The horizontal drive circuit 23 generates the data line signal DT on the basis of the control signal CTLB and the signal data S_{ig}. Each pixel 11 on the display panel 10 performs gray-scale display with pulse width modulation on the basis of the data line signal DT and the scan line signal WS.

### (Detailed Operation)

Next, the detailed operation of the display device 1 will be described by using several operational examples.

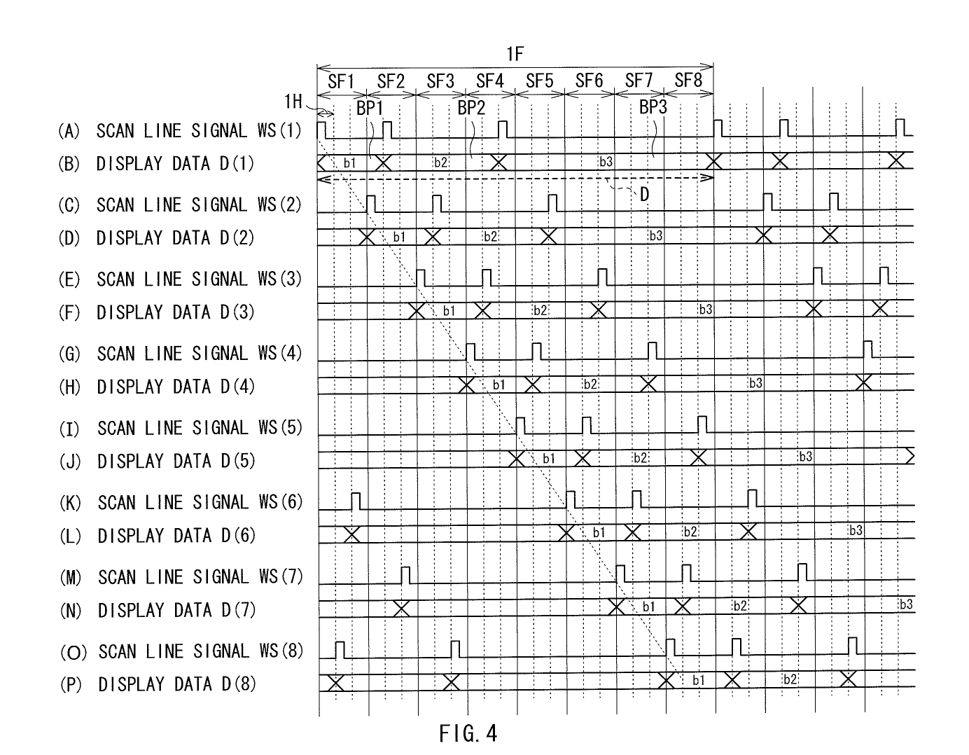

FIG. 4 is an example of a timing chart of a displaying operation in a first example. This example illustrates a case in which eight scan lines WSLs are prepared for the convenience of description. In addition, it is assumed that an 8-step gray-scale code that includes pieces of 3-bit gray-scale data b1 to b3 is used as the gray-scale data C. In FIGS. 3, (A), (C), (E), (G), (I), (K), (M), and (O) respectively indicate eight scan line signals WS(1) to WS(8), and (B), (D), (F), (H), (J), (L), (N), and (P) respectively indicate display data of the pixels 11 (1) to 11 (8) for eight rows.

In this example, the one-frame period (1F) is divided into eight sub-frame periods SF (SF1 to SF8) having mutually equal time widths and each sub-frame period SF is divided into three horizontal periods (1H) as illustrated in FIG. 4. That is, the one-frame period is divided into the sub-frame periods SF of the same number as that of the scan lines WSLs, and each sub-frame period SF is divided into the horizontal periods of the same number as that of the bits in the gray-scale code C in this example.

First, an example of the operation of the first-row pixel 11 (the pixel 11 in the first row) on the display panel 10 will be described.

The horizontal drive circuit 23 applies a voltage corresponding to the bit b1 in the gray-scale code C to the data line DTL and the vertical drive circuit 22 applies a scanning pulse to the first-row scan line WSL(1) in the first horizontal period within the sub-frame period SF1 in the display device 1 ((A) of FIG. 4). Thus, the value of the bit b1 is written into the first-row pixel 11 and the pixel 11 maintains the value so written for a period (the bit plane BP1) taken until the next writing is performed ((B) of FIG. 4).

Next, the horizontal drive circuit 23 applies a voltage corresponding to the bit b2 in the gray-scale code C to the data line DTL and the vertical drive circuit 22 applies a scanning pulse to the first-row scan line WSL(1) similarly in the second horizontal period in the sub-frame period SF2 ((A) of FIG. 4). Thus, the value of the bit b1 is written into the first-row pixel 11 and the pixel 11 maintains the value so written for a period (the bit plane BP2) taken until the next writing is performed ((B) of FIG. 4).

Next, the horizontal drive circuit 23 applies a voltage corresponding to the bit b2 in the gray-scale code C to the data line DTL and the vertical drive circuit 22 applies a scanning pulse to the first-row scan line WSL(1) in the third horizontal period in the sub-frame period SF4 ((A) of FIG. 4). Thus, the value of the bit b1 is written into the first-row pixel 11 and the pixel 11 maintains the value so written for the period (the bit plane BP3) taken until the next writing is performed ((B) of FIG. 4).

The first-row pixel 11 performs gray-scale display in the driving period D that includes three bit planes BP1 to BP3 in the above mentioned manner.

The display device 1 performs a displaying operation of one frame by shifting the start timing of the driving period D row by row. Specifically, for example, the driving period D starts from the first horizontal period in the sub-frame SF1 for the first-row pixel 11, it starts from the first horizontal period in the sub-frame period SF2 for the second-row pixel 11, and it starts from the first horizontal period in the sub-frame period SF3 for the third-row pixel 11. In the above mentioned case, the vertical drive circuit 22 operates so as not to apply the scanning pulses to the mutually different rows together. Thus, the pixels 11 on the respective rows are allowed to perform display independently of one another.

The vertical drive circuit 22 performs scanning while sequentially selecting the scan line WSL to be subjected to the driving operation, in order to perform a displaying operation as mentioned above. Specifically, for example, the vertical drive circuit 22 applies a scanning pulse to the first-row scan line WSL (1) in the first horizontal period in the sub-frame period SF1, applies a scanning pulse to the eighth-row scan line WSL (8) in its second horizontal period, and applies a scanning pulse to the sixth-row scan line WSL (6) in its third horizontal period. Next, the vertical drive circuit 22 applies a scanning pulse to the second-row scan line WSL(2) in the first horizontal period in the subsequent sub-frame period SF2, applies a scanning pulse to the first-row scan line WSL(1) in its second horizontal period, and applies a scanning pulse to the seventh-row scan line WSL(7) in its third horizontal period. Then, the horizontal drive circuit 23 applies the corresponding gray-scale data to the data line DTL at respective timings. Thus, the gray-scale data is written into the pixel 11 on the row selected by the vertical drive circuit 22.

In the display device 1, the controller 21 sets the row onto which the gray-scale data is to be written per horizontal period and generates the address signal ADR. Then, the vertical drive circuit 22 performs the scanning as mentioned above on the basis of the address signal ADR.

The controller 21 is configured to set, on an optional basis, the row onto which the gray-scale data is to be written. Thus, performance of displaying operations, for example, as described below is allowed in addition to the above mentioned displaying operation.

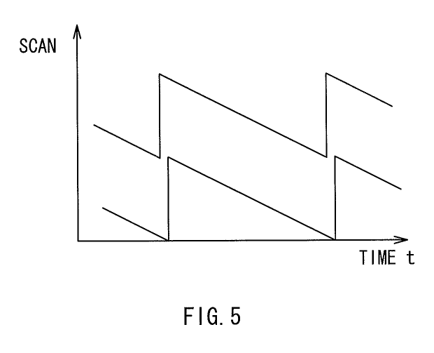

FIG. 5 schematically illustrates a second example of the displaying operations. In this example, the display device 1 performs the displaying operation so as to separately scan an upper half part and a lower half part of the display screen.

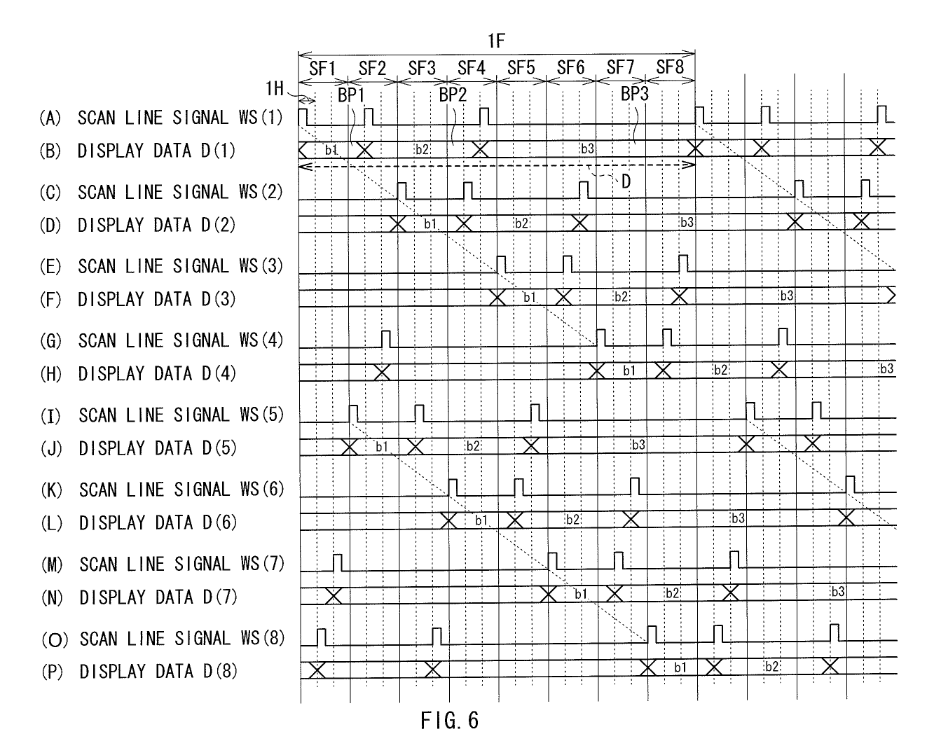

FIG. 6 illustrates an example of a timing chart of the displaying operation in a second example. In the second example, the driving period D starts from the first horizontal period of the sub-frame period SF1 for the first-row pixel 11, starts from the first horizontal period of the sub-frame period SF3 for the second-row pixel 11, starts from the first horizontal period of the sub-frame period SF5 for the third-row pixel 11, and starts from the first horizontal period of the sub-frame period SF7 for the fourth-row pixel 11. The driving period D starts from the first horizontal period of the sub-frame period SF2 for the fifth-row pixel 11, starts from the first horizontal period of the sub-frame period SF4 for the sixth-row pixel 11, starts from the first horizontal period of the sub-frame period SF6 for the seventh-row pixel 11, and starts from the first horizontal period of the sub-frame period SF8 for the eighth-row pixel 11 similarly.

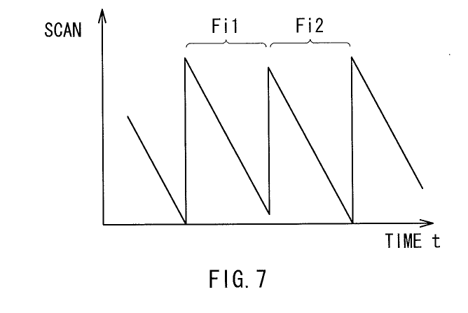

FIG. 7 schematically illustrates a third example of the displaying operation. In the third example, the display device 1 performs so-called interlace-display.

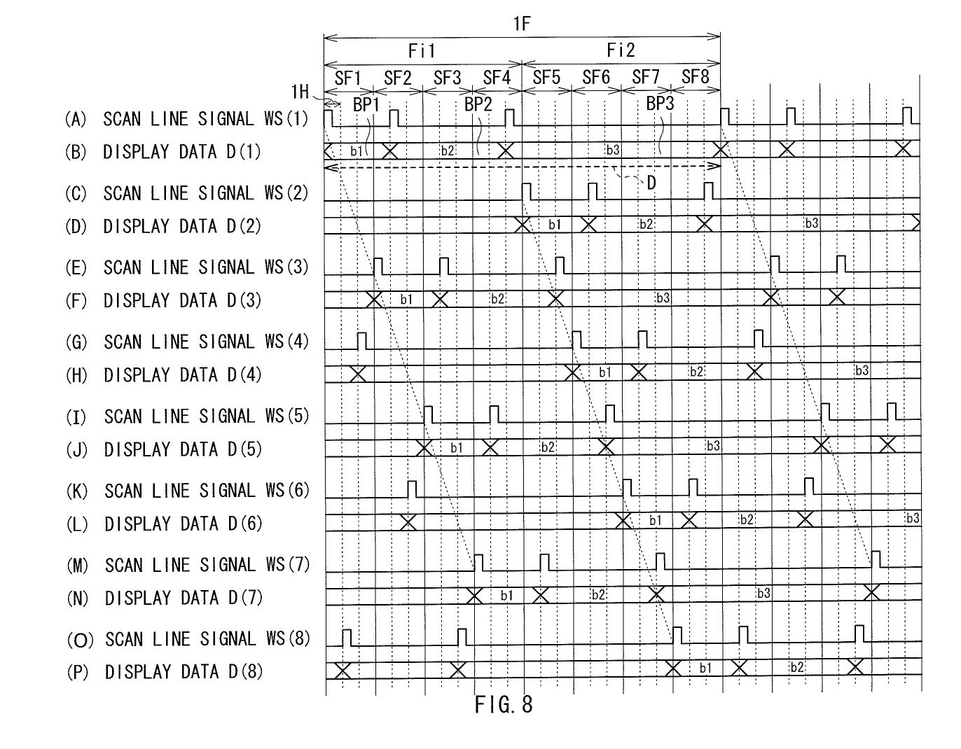

FIG. 8 illustrates an example of a timing chart of the displaying operation in the third example. In the third example, the driving period D starts from the first horizontal period of the sub-frame period SF1 for the first-row pixel 11, starts from the first horizontal period of the sub-frame period SF2 for the third-row pixel 11, starts from the first horizontal period of the sub-frame period SF3 for the fifth-row pixel 11, and starts from the first horizontal period of the sub-frame period SF4 for the seventh-row pixel 11. The driving period D starts from the first horizontal period of the sub-frame period SF5 for the second-row pixel 11, starts from the first horizontal period of the sub-frame period SF6 for the fourth-row pixel 11, starts from the first horizontal period of the sub-frame period SF7 for the sixth-row pixel 11, and starts from the first horizontal period of the sub-frame period SF8 for the eighth-row pixel 11 similarly.

Next, transmission and reception of the address signal ADR in the peripheral circuit 20 will be described. In the following description, it is assumed that the display device 1 handles the HD image (1920 pixels×1080 pixels).

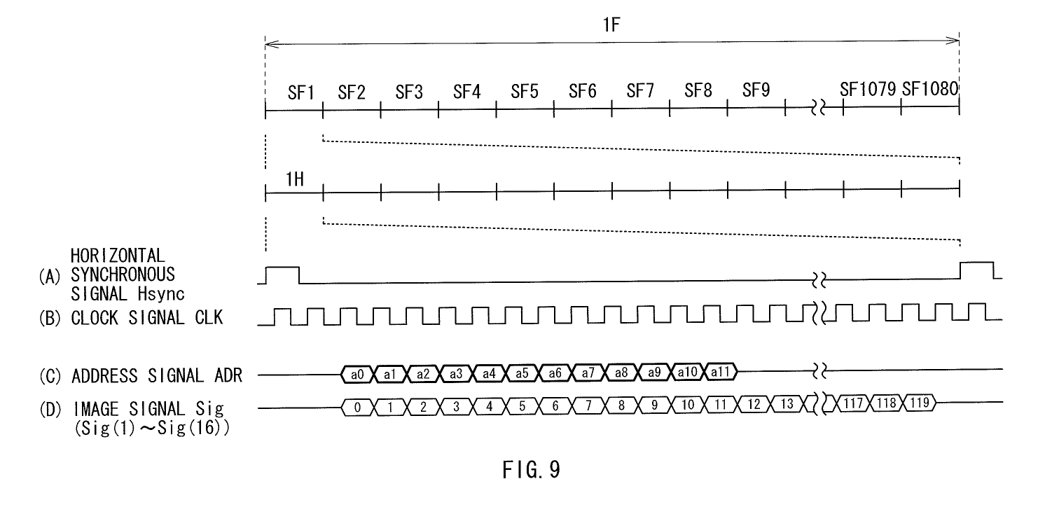

FIG. 9 illustrates an example of a timing chart of a circuit operation of the peripheral circuit 20. (A) of FIG. 9 illustrates an example of the waveform of the horizontal synchronous signal H_{sync}, (B) of FIG. 9 illustrates an example of the waveform of the clock signal CLK, (C) of FIG. 9 illustrates an example of the waveform of the address signal ADR, and (D) of FIG. 9 illustrates an example of the waveform of the image signal S_{ig} (S_{ig} (1) to S_{ig} (16)). In this example, the one-frame period (1F) is divided into 1080 sub-frame periods SFs (SF1 to SF1080), and each sub-frame period SF is divided into twelve horizontal periods (1H).

The conversion circuit 30 supplies the image signal S_{ig} (S_{ig}(1) to S_{ig}(16)) that includes sixteen parallel signals to the horizontal drive circuit 23 in synchronization with the clock signal CLK in each horizontal period (1H) ((D) of FIG. 9). In the above mentioned case, since each image signal S_{ig} transmits 120-bit data, the conversion circuit 30 supplies data for 1920 (120×16) bits in each horizontal period. Then, the horizontal drive circuit 23 generates the data line signal DT on the basis of the image signal S_{ig} (S_{ig} (1) to S_{ig} (16)), and outputs the thus-generated data line signal DT onto the data line DTL in the subsequent horizontal period.

Together with the above mentioned operation, the controller 21 sequentially supplies the respective pieces of 12-bit address data (a0 to a11) to the vertical drive circuit 22 as the address signal ADR in synchronization with the clock signal CLK.That is, the controller 21 supplies the respective pieces of 12-bit address data (a0 to a11) as serial signals. Then, the vertical conversion circuit 22 performs row selection involving writing in the subsequent horizontal period on the basis of the address signal ADR.

Thus, gray-scale data which is based on the gray-scale code C relating to the row so selected on the basis of the address signal ADR is supplied to the pixel 11 included in that row, by which writing is performed on the selected row on the display panel 10.

Since the controller 21 sets the row on which the writing operation is to be performed and generates the address signal ADR per horizontal period, and the vertical drive circuit 22 performs row selection on the basis of that address signal ADR in the display device 1 as described above, so-called random access to the display panel 10 is allowed, making it possible to increase the degree of freedom of display.

### [Effects]

In the first embodiment, the controller sets the row on which the writing operation is to be performed and generates the address signal ADR per horizontal period as described above. Thus, so-called random access to the display panel is allowed. Hence, it is allowed to increase the degree of freedom of display.

In the first embodiment, the address signal is directly supplied from the controller to the vertical drive circuit as the serial signal. Hence, it is allowed to implement a relatively simple circuit configuration.

### Modification Example 1-1

Although the vertical drive circuit 22 performs, in a horizontal period that comes after the horizontal period during which the address signal ADR has been supplied, row selection on the basis of that address signal ADR in the first embodiment, it is not limited to the above. Alternatively, for example, in the horizontal period during which the address signal ADR has been supplied, row selection may be performed on the basis of that address signal ADR.

### Modification Example 1-2

Although one set of the 12-bit address data (a0 to a11) is transferred per horizontal period in the first embodiment, it is not limited to the above. Alternatively, for example, two sets of the 12-bit address data (a0 to a11) may be transferred once every two horizontal periods, i.e., the address information of the predetermined number of horizontal lines may be supplied for each set of the predetermined number of the horizontal periods.

### Modification Example 1-3

Although the address signal ADR takes the form of the serial signal in the first embodiment, it is not limited to the above. Alternatively, for example, it may be a parallel signal such as, for example, a 2-bit parallel signal. In addition, although the time width of each of the bits a0 to a11 of the address signal is made the same as the width of each bit of the image signal S_{ig} in the first embodiment, it is not limited to the above. Alternatively, for example, it may have a time width corresponding to a width of two clock pulses.

### 2. Second Embodiment

Next, a display device 2 according to a second embodiment will be described. In the second embodiment, the controller supplies the address signal indirectly to the vertical drive circuit using a bus which is the same as that of the image signal S_{ig}. It is to be noted that the same numerals are assigned to the constitutional parts which are substantially the same as those in the display device 1 according to the first embodiment and description thereof will be properly omitted.

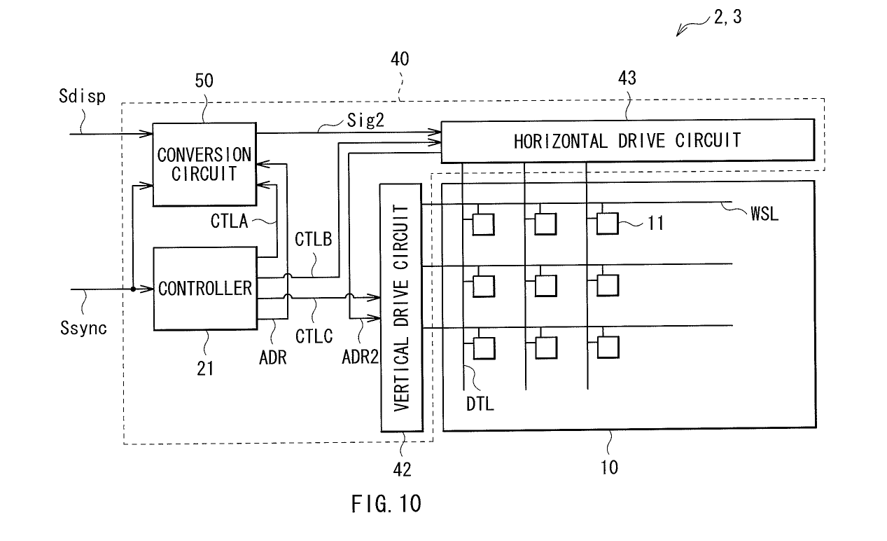

FIG. 10 illustrates a configuration example of the display device 2 according to the second embodiment. The display device 2 includes a peripheral circuit 40. The peripheral circuit 40 includes a conversion circuit 50, a horizontal drive circuit 43, and a vertical drive circuit 42.

The conversion circuit 50 converts the image signal S_{disp} which is in synchronization with the synchronous signal S_{sync} into an image signal suited for driving the display panel 10, time-divisionally multiplexes the address signal ADK that has been supplied from the controller 21 and the image signal so converted, and outputs the signal so multiplexed as an image signal S_{ig}2.

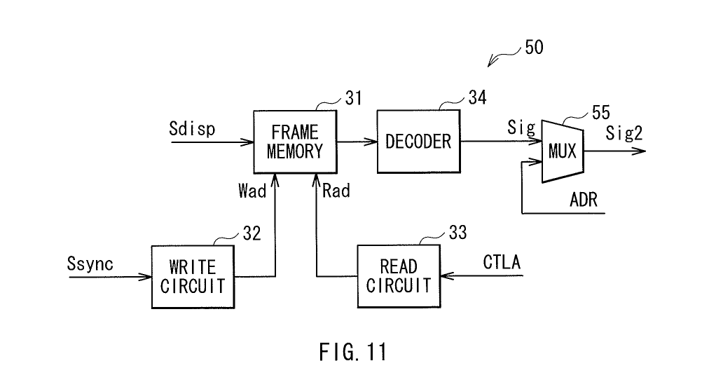

FIG. 11 illustrates a configuration example of the conversion circuit 50. The conversion circuit 50 includes a multiplexer (MUX) 55. The multiplexer 55 time-divisionally multiplexes the image signal Sig, which is the 16-bit parallel signal supplied from the decoder 34, and each of the respective pieces of the address data a0 to a11 included in the address signal ADR, to generate the image signal S_{ig}2 which is a 16-bit parallel signal.

The horizontal drive circuit 43 generates the data line signal DT that includes the gray-scale data of each pixel 11 on the basis of the control signal CTLB and the image signal S_{ig}2, and outputs the thus-generated data line signal DT onto the data line DTL as in the horizontal drive circuit 23 according to the first embodiment. In addition, the horizontal drive circuit 43 also has a function of extracting the respective pieces of address data a0 to a11 from within the image signal S_{ig}2 to generate an address signal ADR2, and supplying the thus-generated address signal ADR2 to the vertical drive circuit 42.

The vertical drive circuit 42 generates the scan line signal WS that includes the scanning pulses used to select the respective pixels 11 in units of rows on the basis of the control signal CTLC and the address signal ADR2, and outputs the thus-generated scan line signal WS onto the scan line WSL as in the vertical drive circuit 22 according to the first embodiment. In the above mentioned case, the vertical drive circuit 42 selects the respective pixels 11 in units of rows on the basis of the address signal ADR2 in the horizontal period during which the address signal ADR2 has been supplied.

Here, the vertical drive circuit 42 corresponds to a specific but not limitative example of the “scan driving section” in one embodiment of the present disclosure. The horizontal drive circuit 43 corresponds to a specific but not limitative example of the “display driving section” in one embodiment of the present disclosure.

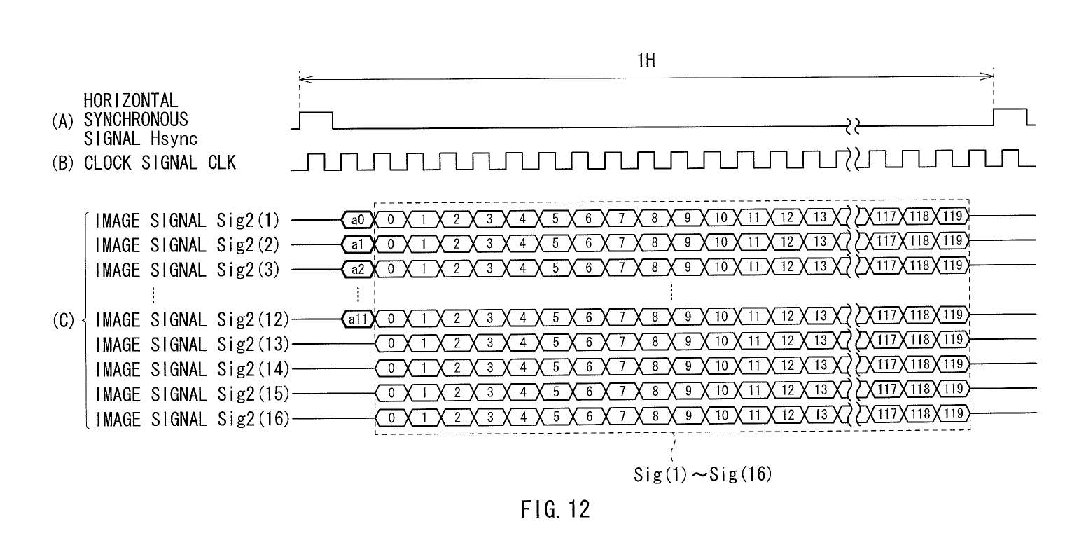

FIG. 12 illustrates an example of a timing chart of an operational example of the peripheral circuit 40, in which (A) of FIG. 12 illustrates an example of the waveform of the horizontal synchronous signal H_{sync}, (B) of FIG. 12 illustrates an example of the waveform of the clock signal CLK, and (C) of FIG. 12 illustrates examples of the waveforms of the image signals S_{ig}2(1) to S_{ig}2(16).

The conversion circuit 50 supplies the image signal S_{ig}2 (S_{ig}2(1) to S_{ig}2(16)) that includes sixteen parallel signals to the horizontal drive circuit 43 in synchronization with the clock signal CLK in each horizontal period (1H) ((C) of FIG. 12). In the above mentioned case, the multiplexer 55 of the conversion circuit 50 performs time division multiplexing so as to arrange the respective pieces of address data a0 to a11, in the address signal ADR supplied from the controller 21, before the respective pieces of data of the image signal S_{ig} (S_{ig}(1) to S_{ig}(16)) for 1920 (120×16) bits. It is to be noted that the multiplexer 55 arranges the respective pieces of address data a0 to a11 respectively before twelve image signals (the image signals S_{ig}2(1) to S_{ig}2(12)) of the sixteen image signals S_{ig}2(1) to S_{ig}2(16) in this example.

The horizontal drive circuit 43 extracts the image signal Sig from within the image signal S_{ig}2 (S_{ig}2(1) to S_{ig}2(16)) and drives the display panel 10 on the basis of the image signal S_{ig}. In addition, the horizontal drive circuit 43 extracts the respective pieces of address data a0 to a11 from within the image signal S_{ig}2 and supplies the thus-extracted respective pieces of address data a0 to a11 to the vertical drive circuit 42 as the address signal ADR2. Then, the vertical drive circuit 42 performs row selection involving writing in the horizontal period (1H) concerned on the basis of that address signal ADR2.

That is, since the respective pieces of address data a0 to a11 are transmitted and received as parallel data in the display device 2 according to the second embodiment, it is allowed to supply the respective pieces of address data a0 to a11 to the vertical drive circuit 42 at an early stage of one horizontal period (1H) as compared with the case of the display device 1 according to the first embodiment (FIG. 9). Thus, the vertical drive circuit 42 is allowed to afford the time for performing row selection after the respective pieces of address data a0 to a11 have been supplied in the above horizontal period.

The address data is transmitted and received as the parallel data as described above in the second embodiment. Hence, in the horizontal period during which the address signal has been supplied, it is allowed to perform row selection on the basis of that address signal.

In addition, the address data and the image signal are time-divisionally multiplexed in transmission and reception of the address data as the parallel data in the second embodiment. Thus, addition of a new bus may be avoided. Hence, it is allowed to simplify the configuration.

Other effects are the same as those of the first embodiment.

### Modification Example 2-1

Although the vertical drive circuit 42 performs, in the horizontal period during which the address signal ADR2 has been supplied, row selection on the basis of that address signal ADR2 in the second embodiment, it is not limited to the above. Alternatively, for example, in a horizontal period that comes after the horizontal period during which the address signal ADR has been supplied, row selection may be performed on the basis of that address signal ADR2. Even in the latter case, random access is allowed, making it possible to increase the degree of freedom of display as in the case in the first embodiment.

In addition, in the above mentioned case, for example, the multiplexer 55 may perform time division multiplexing so as to arrange the respective pieces of address data a0 to a11 subsequent to the respective pieces of data of the image signal S_{ig} (S_{ig}(1) to S_{ig}(16)) for 1920 (120×16) bits in the image signal S_{ig}2.

### Modification Example 2-2

Although one set of the 12-bit address data (a0 to a11) is transferred in each horizontal period in the second embodiment, it is not limited to the above. Alternatively, for example, two sets of the 12-bit address data (a0 to a11) may be transferred once every two horizontal periods, i.e., the address information of the predetermined number of the horizontal lines may be supplied for each set of the predetermined number of the horizontal periods.

### 3. Third Embodiment

Next, a display device 3 according to a third embodiment will be described. In the third embodiment, every two tows of the pixels 11 on the display panel 10 are driven. It is to be noted that the same numerals are assigned to the constitutional parts which are substantially the same as those of the display device 1 according to the first embodiment and description thereof will be properly omitted.

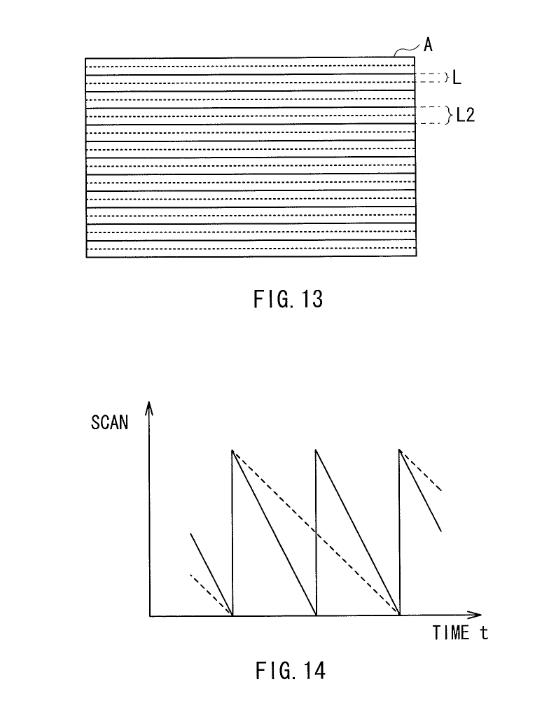

FIG. 13 schematically illustrates an example of a driving method of the display device 3 according to the third embodiment. In the display device 3, the display panel is driven not row by row (a line L), but in units of two rows (a line L2), i.e., on a two-row basis. Specifically, the display device 3 is configured such that a vertical drive circuit (for example, the vertical drive circuit 22 or 42 according to one of the above mentioned embodiments) applies scanning pulses together to two scan lines WSLs so as to drive the pixels 11 in units of two rows.

Since the number of effective lines involving driving is halved by driving the pixels in units of two rows in the display device 3, various effects are obtained. Next, the effects will be described by giving several examples.

FIG. 14 schematically illustrates one example of a displaying operation of the display device 3. In this example, the display 3 is allowed to perform scanning at a speed which is two times faster than the speed for row-by-row driving (a broken line). In other words, the display device 3 is allowed to increase a refresh rate of display. That is, the example illustrated in FIG. 14 illustrates that scanning is accelerated just as much as the reduced number of effective lines.

In addition, gray-scale display on the pixel 11 is made fine just as much as the reduced number of effective lines. Next, an example thereof will be described.

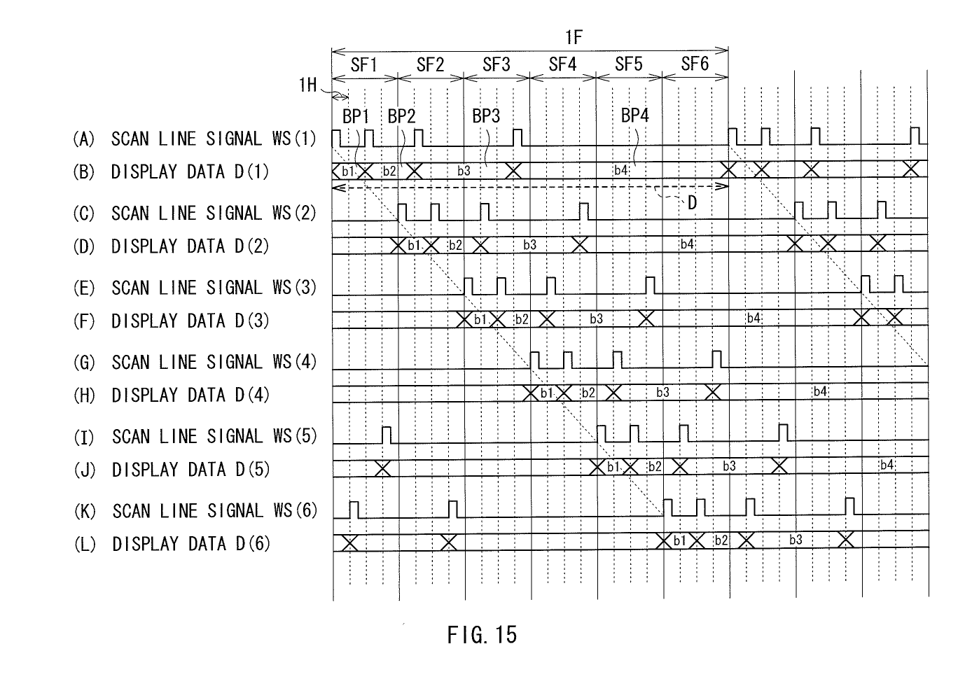

FIG. 15 illustrates an example of a timing chart of an example of a displaying operation performed when gray-scale display is made finer. This example illustrates a case in which the number of the scan lines WSLs is six for the convenience of description. That is, FIG. 15 illustrates a case in which the number of scan lines WSLs is reduced as compared with the case, for example, illustrated in FIG. 4.

In this example, the driving period D includes four bit planes BP1 to BP4 as illustrated in FIG. 15. That is, in this example, the gray-scale code C is a 16-step gray-scale code that includes pieces of 4-bit gray-scale data b1 to b4 and the number of grayscale steps is two times as many as that of the case illustrated in FIG. 4.

Since the number of effective lines is reduced in the display device 3 as compared with the case that row-by-row driving is performed, gray-scale display on the pixel 11 is made finer similarly.

It is to be noted that since the number of effective lines is reduced by driving the pixels 11 in units of two rows, the resolution in a vertical direction of the display panel 10 is halved in the third embodiment. Thus, the resolution in the vertical direction is made equal to that of the HD image (2K1K), for example, by using a so-called 4K2K panel as the display panel 10. Then, the amount corresponding to the reduced number of effective lines may be utilized to increase the fresh rate as illustrated in FIG. 14, or to make fine the gray-scale display of the pixel 11 as illustrated in FIG. 15 by arranging the driving method as described above.

Next, a circuit operation of a peripheral circuit according to the third embodiment will be described. The third embodiment is applicable to both the display device 1 (FIG. 1) according to the first embodiment and to the display device 2 (FIG. 10) according to the second embodiment.

First, a case in which the third embodiment is applied to the display device 1 (FIG. 1) will be described.

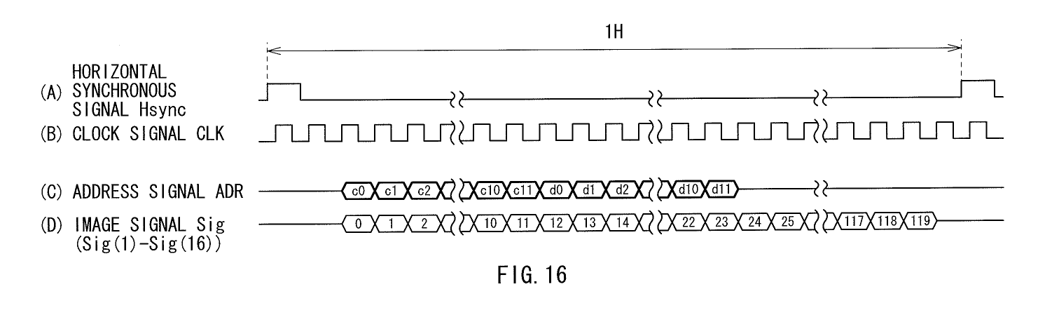

FIG. 16 illustrates an example of a timing chart of an example of a circuit operation of a peripheral circuit 20′ according to the third embodiment, in which (A) of FIG. 16 illustrates an example of the waveform of the horizontal synchronous signal H_{sync}, (B) of FIG. 16 illustrates an example of the waveform of the clock signal CLK, (C) of FIG. 16 illustrates an example of the waveform of the address signal ADR, and (D) of FIG. 16 illustrates an example of the waveform of the image signal S_{ig} (S_{ig}(1) to S_{ig}(16)).

The conversion circuit 30 supplies the image signal S_{ig} (S_{ig}(1) to S_{ig}(16)) that includes sixteen parallel signals to the horizontal drive circuit 23 in synchronization with the clock signal CLK in each horizontal period (1H) ((D) of FIG. 16).

Together with the above mentioned operation, the controller 21 supplies 12-bit address data (c0 to c11) and 12-bit address data (d0 to d11) to the vertical drive circuit 22 as the address signal ADR in synchronization with the clock signal CLK. Then, the vertical drive circuit 22 performs row selection involving writing in the subsequent horizontal period (1H) on the basis of that address signal ADR.

Thus, gray-scale data which is based on the gray-scale code C is supplied to the pixels 11 included in the two rows so selected on the basis of the address signal ADR, by which writing is performed on the selected rows on the display panel 10.

Next, an example in which the third embodiment is applied to the display device 2 (FIG. 10) will be described. In this example, a 32-bit parallel signal is used as the image signal S_{ig}2.

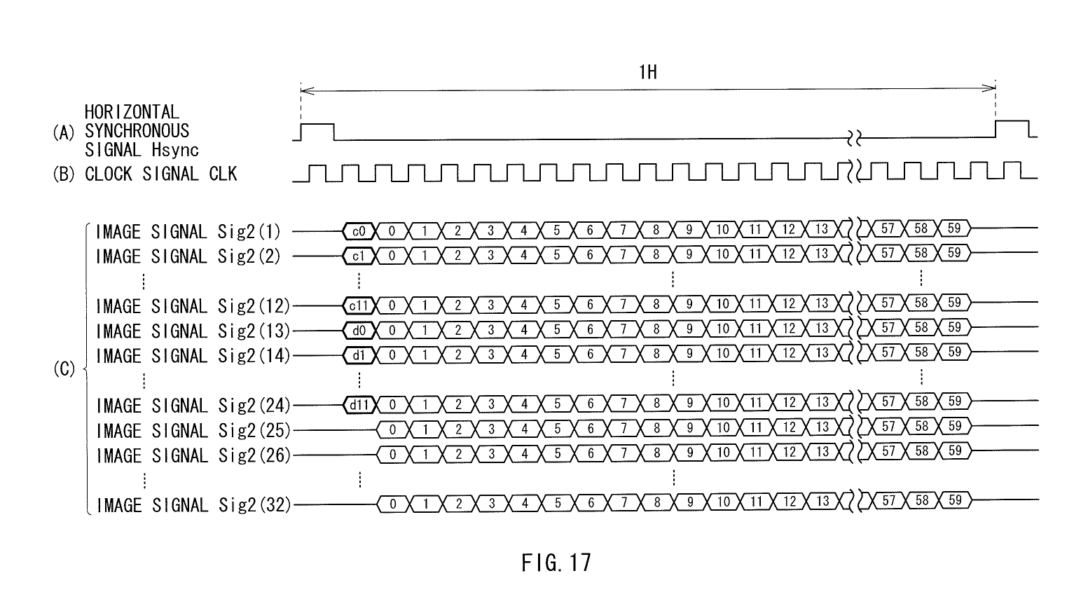

FIG. 17 illustrates an example of a timing chart of an example of a circuit operation of a peripheral circuit 40′ according to the third embodiment, in which (A) of FIG. 17 illustrates an example of the waveform of the horizontal synchronous signal H_{sync}, (B) of FIG. 17 illustrates an example of the waveform of the clock signal CLK, and (C) of FIG. 17 illustrates examples of the waveforms of the image signals S_{ig}2(1) to S_{ig}2(32).

The conversion circuit 50 supplies the image signal S_{ig}2 (S_{ig}2(1) to S_{ig}2(32)) that includes thirty-two parallel signals to the horizontal drive circuit 43 in synchronization with the clock signal CLK in each horizontal period (1H) ((C) of FIG. 17). In the above mentioned case, the multiplexer 55 of the conversion circuit 50 performs time division multiplexing so as to arrange the respective pieces of address data c0 to c11 and the respective pieces of address data d0 to d11, included in the address signal ADR which has been supplied from the controller 21, before the respective pieces of data of the image signals S_{ig} (S_{ig}(1) to S_{ig}(32)) for 1920 bits (60×32). It is to be noted that the multiplexer 55 arranges the respective pieces of address data c0 to c11 before the respective image signals S_{ig}2(1) to S_{ig}2(12) of the thirty-two image signals S_{ig}2(1) to S_{ig}2(32) and arranges the respective pieces of address data d0 to d11 before the respective image signals S_{ig}2(13) to S_{ig}2(24) in this example.

The horizontal drive circuit 43 extracts the image signal S_{ig} from within the image signal S_{ig}2 ((S_{ig}2(1) to S_{ig}2(32)) and drives the display panel 10 on the basis of that image signal Sig. The horizontal drive circuit 43 also extracts the respective pieces of address data c0 to c11 and the respective pieces of address data d0 to d11 from within the image signal Sig2, and supplies them to the vertical drive circuit 42 as an address signal ADR2. Then, the vertical drive circuit 42 selects two rows involving writing in the horizontal period (1H) concerned on the basis of that address signal ADR2.

Thus, gray-scale data which is based on the gray-scale code C is supplied to the pixels 11 included in the two rows so selected on the basis of the address signal ADR2, by which writing is performed on the selected rows on the display panel 10.

Since the third embodiment is configured to transmit and receive the address data for two rows per horizontal period as described above, it is allowed to increase the degree of freedom of display, for example, in that the refresh rate is increased to make gray-scale display of the pixels fine. Other effects are the same as those obtained from the first embodiment and the second embodiment.

### Modification Example 3-1

Although the address data in two rows is transmitted and received per horizontal period as described above in the third embodiment, it is not limited to the above. Alternatively, for example, address data for three or more rows may be transmitted and received.

### Modification Example 3-2

In addition, although two adjacent rows on the display panel 10 are driven simultaneously in the third embodiment, it is not limited to the above. Alternatively, for example, mutually separated two rows may be driven simultaneously.

### 4. Application Examples

Next, application examples of the display devices described in the above mentioned embodiments and modification examples will be described.

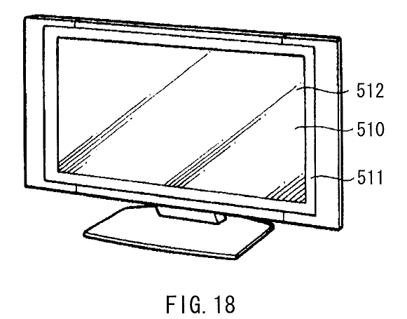

FIG. 18 illustrates an example of an external appearance of a television set to which the display device according to any one of the above mentioned embodiments and the like is to be applied. This television set includes, for example, an image display screen section 510 that includes a front panel 511 and filter glass 512. The image display screen section 510 is configured by the display device according to any one of the above mentioned embodiments and the like.

The display device according to any one of the above mentioned embodiments and the like is applicable to any electronic system in all fields such as, for example, a digital camera, a notebook personal computer, a portable terminal such as a cell phone, or the like, a hand-held game console, a video camera, a projector, and the like, in addition to its application to the television set as mentioned above. In other words, the display device according to any one of the above mentioned embodiments and the like is applicable to any electronic system in all fields involving image display.

Although the present technology has been described so far by giving the embodiments and modification examples, and its application examples to the electronic system, the present technology is not limited to the above mentioned embodiments and the like and may be modified in a variety of ways.

For example, although the one-frame period is divided into the sub-frame periods SFs of the same number as that of the scan lines WSLs in each of the above mentioned embodiments, and the like, it is not limited to the above. Alternatively, for example, it may be divided into the sub-frame periods SFs of the number larger than that of the scan lines WSLs.

In addition, for example, although the values of the respective bits in the gray-scale code C are written into the respective pixels 11 in order starting from the low-order bit b1 in any one of the above mentioned embodiments and the like as illustrated in FIG. 2, it is not limited to the above. Alternatively, for example, the bit values may be written into the pixels starting from the high-order bit b12.

Further, for example, although the time widths of the bit planes BP are set at the ratio of 1:2:4:8: . . . in accordance with the weights of the bits in any one of the above mentioned embodiments and the like, it is not limited to the above and the ratio may be slightly changed within a range not affecting the image quality.

Accordingly, it is possible to achieve at least the following configurations from the above-described example embodiments and the modifications of the disclosure.

(1) A display device, including:

a display section including a plurality of display pixels;

a control section generating address information by which a horizontal line to be driven is designated; and

a driving section driving, at a drive interval that conforms to a weight of each bit in a gray-scale code that includes the bits, the display pixels based on a value of each of the bits, within a unit driving period that is set to drive the horizontal line designated by the address information,

wherein the control section sets a start timing of the unit driving period on an optional basis.

(2) The display device according to (1), wherein the control section sets the start timing to allow the unit driving period to be started in order that is different from arrangement order of the horizontal lines in the display section.
(3) The display device according to (2), wherein

each frame period includes a plurality of sub-frame periods having mutually-equal time widths, and

the control section sets the start timing on a sub-frame period basis.

(4) The display device according to (3), wherein

each of the sub-frame periods is divided into a plurality of horizontal periods having mutually-equal time widths, and

the driving section drives the display pixels on a horizontal period basis.

(5) The display device according to (4), wherein the control section supplies to the driving section the address information for each of the horizontal periods.
(6) The display device according to (5), wherein the control section supplies to the driving section the address information of the horizontal line to be driven in the subsequent horizontal period.
(7) The display device according to (5), wherein the control section generates the address information of the horizontal line to be driven in the current horizontal period.
(8) The display device according to any one of (1) to (7), wherein the control section outputs the address information as a serial signal.
(9) The display device according to any one of (4) to (7), wherein the control section outputs, as a parallel signal, each of the bits in the gray-scale code to a bus having a predetermined bit width, and outputs, as a parallel signal, the address information to at least a part of the bus.
(10) The display device according to (9), wherein the control section arranges the address information before each of the bits in the gray-scale code, in each of the horizontal periods.
(11) The display device according to (9),

wherein the driving section includes:

a scan driving section that selects, based on the address information, the horizontal line to be driven; and

a display driving section that supplies to the display pixels a voltage corresponding to the value of each of the bits in the gray-scale code,

wherein the control section supplies to the display driving section the gray-scale code and the address information, and

wherein the display driving section supplies to the scan driving section the address information.

(12) The display device according to any one of (4) to (11), wherein the control section supplies to the driving section, for each set of the predetermined number of the horizontal periods, the address information of the predetermined number of the horizontal lines.
(13) The display device according to any one of (4) to (11), wherein the control section supplies to the driving section the address information of the plurality of horizontal lines for each of the horizontal periods.
(14) The display device according to any one of (1) to (13), wherein time of the unit driving period is equal to time of a one-frame period.
(15) A drive circuit, including:

a control section generating address information by which a horizontal line to be driven in a display section is designated, the display section including a plurality of display pixels; and

a driving section driving, at a drive interval that conforms to a weight of each bit in a gray-scale code that includes the bits, the display pixels based on a value of each of the bits, within a unit driving period that is set to drive the horizontal line designated by the address information,

wherein the control section sets a start timing of the unit driving period on an optional basis.

(16) A driving method, including:

generating address information by which a horizontal line to be driven in a display section is designated, the display section including a plurality of display pixels;

driving, at a drive interval that conforms to a weight of each bit in a gray-scale code that includes the bits, the display pixels based on a value of each of the bits, within a unit driving period that is set to drive the horizontal line designated by the address information; and

setting a start timing of the unit driving period on an optional basis.

(17) An electronic system, including:

a display device; and

a control section performing operation control that utilizes the display device,

wherein the display device includes

a display section including a plurality of display pixels,

a control section generating address information by which a horizontal line to be driven is designated, and

a driving section driving, at a drive interval that conforms to a weight of each bit in a gray-scale code that includes the bits, the display pixels based on a value of each of the bits, within a unit driving period that is set to drive the horizontal line designated by the address information, and

wherein the control section sets a start timing of the unit driving period on an optional basis.

It is to be noted that any combinations of (2) to (14) directed to the display device are also applicable to each of (15) directed to the drive circuit, (16) directed to the driving method, and (17) directed to the electronic system unless any contradictions occur. Such combinations are considered also as preferred combinations of example embodiments according to the technology.

The present application claims priority to Japanese Priority Patent Application JP 2011-207141 filed in the Japan Patent Office on Sep. 22, 2011, the entire content of which is hereby incorporated by reference.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A display device, comprising:
a display section including a plurality of display pixels;
a control section generating address information by which a horizontal line to be driven is designated; and
a driving section driving, at a drive interval that conforms to a weight of each bit in a gray-scale code that includes the bits, the display pixels based on a value of each of the bits, within a unit driving period that is set to drive the horizontal line designated by the address information,
wherein the control section sets a start timing of the unit driving period on an optional basis.

2. The display device according to claim 1, wherein the control section sets the start timing to allow the unit driving period to be started in order that is different from arrangement order of the horizontal lines in the display section.

3. The display device according to claim 2, wherein
each frame period includes a plurality of sub-frame periods having mutually-equal time widths, and
the control section sets the start timing on a sub-frame period basis.

4. The display device according to claim 3, wherein
each of the sub-frame periods is divided into a plurality of horizontal periods having mutually-equal time widths, and
the driving section drives the display pixels on a horizontal period basis.

5. The display device according to claim 4, wherein the control section supplies to the driving section the address information for each of the horizontal periods.

6. The display device according to claim 5, wherein the control section supplies to the driving section the address information of the horizontal line to be driven in the subsequent horizontal period.

7. The display device according to claim 5, wherein the control section generates the address information of the horizontal line to be driven in the current horizontal period.

8. The display device according to claim 1, wherein the control section outputs the address information as a serial signal.

9. The display device according to claim 4, wherein the control section outputs, as a parallel signal, each of the bits in the gray-scale code to a bus having a predetermined bit width, and outputs, as a parallel signal, the address information to at least a part of the bus.

10. The display device according to claim 9, wherein the control section arranges the address information before each of the bits in the gray-scale code, in each of the horizontal periods.

11. The display device according to claim 9,
wherein the driving section includes:
a scan driving section that selects, based on the address information, the horizontal line to be driven; and
a display driving section that supplies to the display pixels a voltage corresponding to the value of each of the bits in the gray-scale code,
wherein the control section supplies to the display driving section the gray-scale code and the address information, and
wherein the display driving section supplies to the scan driving section the address information.

12. The display device according to claim 4, wherein the control section supplies to the driving section, for each set of the predetermined number of the horizontal periods, the address information of the predetermined number of the horizontal lines.

13. The display device according to claim 4, wherein the control section supplies to the driving section the address information of the plurality of horizontal lines for each of the horizontal periods.

14. The display device according to claim 1, wherein time of the unit driving period is equal to time of a one-frame period.

15. A drive circuit, comprising:
a control section generating address information by which a horizontal line to be driven in a display section is designated, the display section including a plurality of display pixels; and
a driving section driving, at a drive interval that conforms to a weight of each bit in a gray-scale code that includes the bits, the display pixels based on a value of each of the bits, within a unit driving period that is set to drive the horizontal line designated by the address information,
wherein the control section sets a start timing of the unit driving period on an optional basis.

16. A driving method, comprising:
generating address information by which a horizontal line to be driven in a display section is designated, the display section including a plurality of display pixels;
driving, at a drive interval that conforms to a weight of each bit in a gray-scale code that includes the bits, the display pixels based on a value of each of the bits, within a unit driving period that is set to drive the horizontal line designated by the address information; and
setting a start timing of the unit driving period on an optional basis.

17. An electronic system, comprising:
a display device; and
a control section performing operation control that utilizes the display device,
wherein the display device includes
a display section including a plurality of display pixels,
a control section generating address information by which a horizontal line to be driven is designated, and
a driving section driving, at a drive interval that conforms to a weight of each bit in a gray-scale code that includes the bits, the display pixels based on a value of each of the bits, within a unit driving period that is set to drive the horizontal line designated by the address information, and
wherein the control section sets a start timing of the unit driving period on an optional basis.
